(19) United States
(12) Patent Application Publication
(10) Pub. No.: US 2009/0206035 A1
(43) Pub. Date: Aug. 20, 2009

(54) Vinylidene Fluoride Resin Hollow Filament Porous Membrane, Water Filtration Method Using the Same, and Process for Producing Said Vinylidene Fluoride Resin Hollow Filament Porous Membrane

(75) Inventors: Takeo Takahashi, Ibaraki-Ken (JP); Yasuhiro Tada, Ibaraki-Ken (JP); Kenichi Suzuki, Tokyo (JP); Masayuki Hino, Ibaraki-Ken (JP); Shingo Taniguchi, Fukushima-Ken (JP); Toshiya Mizuno, Ibaraki-Ken (JP)

Correspondence Address: WENDEROTH, LIND & PONACK, L.L.P., 1030 15th Street, N.W.,, Suite 400 East, Washington, DC, 20005-1503, US

(73) Assignee: KUREHA CORPORATION, Tokyo (JP)

(21) Appl. No.: 11/884,371

(22) PCT Filed: Feb. 9, 2006
(86) PCT No.: PCT/JP2006/302251

§ 371 Date: Aug. 15, 2007

(30) Foreign Application Priority Data
Feb. 15, 2005 (JP) 2005-037556

(51) Int. Cl. B01D 71/34; B01D 69/08; C02F 1/44; B29C 47/06; B01D 67/00

(52) U.S. Cl. 210/636; 210/500.23; 264/173.16

(57) ABSTRACT

A hollow-fiber porous membrane, comprising a hollow fiber-form porous membrane in a network texture of vinylidene fluoride resin showing a pore size distribution in a direction of its membrane thickness including an outer surface-average pore size P1 as measured by a scanning electron microscope and a membrane layer-average pore size P2 as measured by half-dry method giving a ratio P1/P2 of at least 2.5. The hollow-fiber porous membrane is excellent in long-term water filtration performance including efficiency of regeneration by air scrubbing. The hollow-fiber porous membrane is produced through a process, wherein a mixture of vinylidene fluoride resin, a plasticizer and a good solvent for vinylidene fluoride resin, is melt-extruded in a hollow-fiber film and cooled and formed into a solidified film within a cooling medium containing at least a certain proportion of a good solvent for vinylidene fluoride resin.

### TECHNICAL FIELD

The present invention relates to a hollow-fiber porous membrane (hollow fiber-form porous membrane) of vinylidene fluoride resin excellent in not only mechanical strength but also long-term water treating performances inclusive of regeneration efficiency, a water filtration method using the same and a process for production thereof.

### BACKGROUND ART

Vinylidene fluoride resin is excellent in chemical resistance, heat resistance and mechanical strength and, therefore, has been studied with respect to application thereof to porous membranes for separation. In the case of use for water treatment, particularly for production of potable water or sewage treatment, a hollow fiber-form porous membrane is frequently used because it can easily provide a large membrane area per unit volume of filtration apparatus.

A hollow-fiber porous membrane used for the above purpose is required to show mechanical strength such as a tensile strength and an elongation at break which are large too some extent, so as not to cause fiber severance not only during the filtration operation as a matter of course but also during back washing performed to remove clogging of the membrane with time. Further, with respect to clogging with organic matter against which the back washing is liable to show only insufficient washing effect, back washing with water containing sodium hypochlorite or ozone or periodical washing with chemicals is also performed. Further, in some cases, a filtration operation is performed by adding sodium hypochlorite or ozone to raw water (supply water). Accordingly, a porous membrane is required to have a high chemical resistance so as not to lower its mechanical strength (tensile strength, elongation at break) due to such chemicals for a long period.

Vinylidene fluoride resin is generally excellent in weatherability, chemical resistance, heat resistance, strengths, etc. However, vinylidene fluoride resin shows non-adhesiveness and low compatibility, so that its formability is not necessarily good. Further, for the development of porous membranes, a higher porosity and a narrower pore size distribution for achieving an improved separation performance have been intensively pursued, so that porous membranes having necessarily satisfactory mechanical performances have not been obtained so far.

As a process for producing a porous membrane of vinylidene fluoride resin, there has been disclosed a process of mixing an organic liquid, such as diethyl phthalate and hydrophobic silica as inorganic fine powder with vinylidene fluoride resin, melt-forming the mixture and then extracting the organic liquid and inorganic fine powder (Patent document 1 listed below). The thus-obtained porous membrane has a relatively large mechanical strength. However, as an alkaline aqueous solution is used for extracting the hydrophobic silica in the process, the vinylidene fluoride resin constituting the membrane is liable to be deteriorated.

On the other hand, the present inventors, et al. have found that a process of subjecting a vinylidene fluoride resin having a specific molecular weight characteristic to a pore-forming process including stretching is effective for formation of a vinylidene fluoride resin porous membrane having fine pores of appropriate size and distribution and excellent mechanical strength and have made a series of proposals (Patent document 2 below, etc.). However, there remains a strong demand for further improvement in overall performances including filtration performance and mechanical performances required of a porous membrane used as a filtration membrane.

Particularly, as for a hollow-fiber porous membrane used for water treatment, physical washing such as back washing or regenerating treatment by chemical washing for removing clogging with time of the membrane as described above is performed, a regeneration by physical washing is preferred if at all possible, since the chemical washing requires the removal of chemicals from the apparatus system before resuming the filtration operation after the washing. Further, the back washing performed as an ordinary physical washing operation requires a reversal of a water supply side and an outgoing water side from those in the filtration operation after the filtration operation, so that it is difficult to effect the back washing, as desired, during the filtration operation. In contrast thereto, air scrubbing operation which per se is known as a type of physical washing operation is generally performed by applying bubbling air for scrubbing introduced from a lower side of a filtration apparatus to a module of hollow-fiber porous membrane immersed in water (ordinarily, raw supply water) within the filtration apparatus, thereby vibrating the hollow-fiber porous membrane to remove deposits on the outer surface thereof, so that the air scrubbing can be performed without changing the supply water path to the filtration apparatus from the one in the filtration operation but only by supplying water as desired, closing the outgoing water path from the porous membrane and opening a path for discharging waste water after the washing. Accordingly, the air scrubbing can be easily performed, as desired, depending on the degree of lowering in water permeability through the hollow-fiber porous membrane. Accordingly, as an operation for regenerating a hollow-fiber porous membrane, it is preferred to use air scrubbing preferentially and perform a physical washing by back washing or chemical washing only at a necessary and indispensable occasion.

However, it is a present state that such a vinylidene fluoride resin hollow-fiber porous membrane suited for regeneration by air scrubbing has not been developed hitherto.

Patent document 1: JP 3-215535A

Patent document 2: WO2004/081109A

Patent document 3: JP 4-68966B

### DISCLOSURE OF INVENTION

Accordingly, a principal object of the present invention is to provide a hollow-fiber porous membrane of vinylidene fluoride resin excellent in not only mechanical strength but also long-term water-treating performance inclusive of regeneration efficiency by air scrubbing, a water filtration method using the same and a process for production thereof.

According to the present inventors' study, it has been discovered that a hollow-fiber porous membrane showing a ratio of a certain value or larger between an outer surface-average pore size and a membrane layer-average pore size exhibits a remarkably high rate of recovery of water permeability according to air scrubbing after the use thereof and is extremely effective for accomplishing the object of the present invention.

Thus, the hollow-fiber porous membrane of the present invention is characterized by comprising a hollow-fiber-form porous membrane in a network texture of vinylidene fluoride resin showing a pore size distribution in a direction of its membrane thickness including an outer surface-average pore size P1 as measured by a scanning electron microscope and a membrane layer-average pore size P2 as measured by half-dry method giving a ratio P1/P2 of at least 2.5. Herein, the network texture of the hollow-fiber porous membrane is effective for maintaining its water permeability in harmony with mechanical strength. The reason why the air scrubbing efficiency is remarkably increased according to a ratio P1/P2 of at least 2.5 between the outer surface-average pore size P1 as measured by a scanning electron microscope and the membrane layer-average pore size as not been fully clarified as yet but may presumably be because a hollow-fiber porous membrane having a ratio P1/P2 of at least 2.5 has sufficiently enlarged pore sizes on the outer surface of the membrane and is caused to have a minimum pore size layer inside the membrane or on the inner surface of the membrane, and such a pore size distribution across the membrane thickness is effective for removal by air scrubbing of a layer of fine particles deposited on the outer surface. The reason of requiring a P1/P2 of at least 2.5 instead of at least 1.0 is because the average pore size P1 by the SEM observation is a result of direct observation of the outer surface, whereas the average pore size P2 may be dominantly governed by an average pore size at the minimum pore size layer but also be affected by narrowing of pore sizes at sites other than the minimum pore size layer across the membrane thickness.

Further, the water filtration method according to the present invention is characterized by comprising: a step of feeding and passing a supply water from an outer surface-side to an inner surface-side of the above-mentioned hollow-fiber porous membrane to perform filtration, and a step of washing the hollow-fiber porous membrane by air scrubbing.

Further, according to the present inventors' study, it has been also discovered that such a hollow-fiber porous membrane as described above can be formed, in processes developed by the present inventors, et al, as represented by the one of the above-mentioned Patent document 2, by causing the cooling medium to contain a specific proportion of a good solvent for vinylidene fluoride resin. More specifically, the process for producing a hollow-fiber porous membrane of vinylidene fluoride resin is characterized by comprising: adding, to 100 wt. parts of vinylidene fluoride resin, 70-250 wt. parts of a plasticizer and 5-80 wt. parts of a good solvent for vinylidene fluoride resin to form a composition, melt-extruding the composition into a hollow fiber film, introducing the hollow-fiber film into a cooling medium to cool and solidify the film preferentially from its outer surface, and extracting the plasticizer from the hollow-fiber film to provide a hollow-fiber porous membrane, wherein the cooling medium for solidifying the film is caused to contain at least 30 wt. % of a good solvent for vinylidene fluoride resin. In the process, the inclusion of a plasticizer in the composition causes thermally induced phase separation at an appropriate density and promotes fine crystallization of vinylidene fluoride resin; thereby contributing to the formation of a network texture, and the membrane formed after removal of the plasticizer is caused to have a pore size distribution suitable as a microfiltration membrane. As a result, in a typical case, a membrane free from large pores in excess of 0.6 μm can be obtained. Incidentally, Patent document 3 listed above discloses a porous membrane of vinylidene fluoride resin having a pore size distribution across the thickness and having a minimum pore size layer (dense layer) inside the membrane. However, the membrane disclosed therein is a flat membrane formed by casting a solution of vinylidene fluoride resin, followed by evaporation of the solvent by drying, and not a hollow-fiber-form porous membrane suitable for regeneration by air scrubbing. Further, the formation of a dense layer inside the membrane is for preventing the damage of a dense layer most effective for filtration removal of fine particles due to the exposure to the surface of the dense layer, the improvement in regeneratability by air scrubbing intended by the present invention is not suggested at all.

### BRIEF DESCRIPTION OF THE DRAWING

FIG. 1 is a schematic illustration of a water permeability-metering apparatus for evaluating water-treating performances of hollow-fiber porous membranes obtained in Examples and Comparative Examples.

### BEST MODE FOR PRACTICING THE INVENTION

Hereinbelow, the hollow fiber-form porous water filtration membrane of vinylidene fluoride resin of the present invention will be described in order according to the production process of the present invention that is a preferred process for production thereof.

(Vinylidene Fluoride Resin)

In the present invention, a vinylidene fluoride resin having a weight-average molecular weight molecular weight of 2×10⁵-6×10⁵ is used as a principal membrane-forming material. If Mw is below 2×10⁵, the mechanical strength of the resultant porous membrane becomes small. On the other hand, if Mw exceeds 6×10⁵, the texture of phase separation between the vinylidene fluoride resin and the plasticizer tends to become excessively fine to result in a porous membrane exhibiting a lower water permeation rate when used as a microfiltration membrane.

The vinylidene fluoride resin used in the present invention may be homopolymer of vinylidene fluoride, i.e., polyvinylidene fluoride, or a copolymer of vinylidene fluoride together with a monomer copolymerizable with vinylidene fluoride, or a mixture of these. Examples of the monomer copolymerizable with vinylidene fluoride may include: tetrafluoroethylene, hexafluoropropylene, trifluoroethylene, chlorotrifluoroethylene and vinylidene fluoride, which may be used singly or in two or more species. The vinylidene fluoride resin may preferably comprise at least 70 mol % as the constituent unit. Among these, it is preferred to use homopolymer consisting of 100 mol % of vinylidene fluoride in view of its high mechanical strength.

A vinylidene fluoride resin of a relatively high vinylidene fluoride content as described above may preferably be obtained by emulsion polymerization or suspension polymerization, particularly preferably by suspension polymerization.

The vinylidene fluoride resin forming the porous membrane of the present invention is characterized by good crystallinity, i.e., a crystalline property of suppressing growth of spherulites but promoting the formation of network texture in the course of cooling, as represented by a difference Tm2−Tc of at most 32° C., preferably at most 30° C., between an inherent melting point Tm2 (° C.) and a crystallization temperature Tc (° C.) of the resin as determined by DSC measurement in addition to the above-mentioned relatively large weight-average molecular weight of 3×10⁵-6×10⁵.

Herein, the inherent melting point Tm2 (° C.) of resin should be distinguished from a melting point Tm1 (° C.) determined by subjecting a procured sample resin or a resin constituting a porous membrane as it is to a temperature-increase process according to DSC. More specifically, a vinylidene fluoride resin procured generally exhibits a melting point Tm1 (° C.) different from an inherent melting point Tm2 (° C.) of the resin, due to thermal and mechanical history thereof received in the course of its production or heat-forming process, etc. The melting point Tm2 (° C.) of vinylidene fluoride resin defining the present invention defined as a melting point (a peak temperature of heat absorption according to crystal melting) observed in the course of DSC re-heating after once subjecting a procured sample resin to a prescribed temperature increase and decrease cycle in order to remove the thermal and mechanical history thereof, and details of the measurement method will be described prior to the description of Examples appearing hereinafter.

The condition of Tm2−Tc≦32° C. representing the crystallinity of vinylidene fluoride resin forming the porous membrane of the present invention may possibly be accomplished, e.g., by a lowering in Tm2 according to copolymerization, but in this case, the resultant hollow fiber porous membrane is liable to have a lower chemical resistance in some cases. Accordingly, in a preferred embodiment of the present invention, there is used a vinylidene fluoride resin mixture formed by blending 70-98 wt. % of a vinylidene fluoride resin having a weight-average molecular weight molecular weight of 1.5×10⁵-6×10⁵ as a matrix (or principal) resin and 2-30 wt. % of a high-molecular weight vinylidene fluoride resin having an Mw that is at least 1.8 times, preferably at least 2 times, that of the former and at most 1.2×10⁶, for crystallinity modification. According to such a method, it is possible to significantly increase the crystallization temperature Tc without changing the crystal melting point of the matrix resin alone (represented by Tm2 in a range of preferably 170-180° C.). More specifically, by increasing Tc, it becomes possible to accelerate the solidification of the vinylidene fluoride resin at an inner portion of film where the cooling is retarded compared with the film surface(s) and at an inner portion toward an opposite surface in the case of a preferential cooling from one surface, thereby suppressing the growth of spherulites. Tc is preferably at least 143° C.

If Mw of the high-molecular weight vinylidene fluoride resin is below 1.8 times Mw of the matrix resin, it becomes difficult to sufficiently suppress the growth of spherulites. On the other hand, above 1.2×10⁶, the dispersion thereof in the matrix resin becomes difficult.

Further, if the addition amount of the high-molecular weight vinylidene fluoride resin is below 2 wt. %, the effect of suppressing spherulite texture formation is liable to be insufficient, and in excess of 30 wt. %, the texture of phase separation between the vinylidene fluoride resin and the plasticizer is liable to become excessively fine, thus lowering the water permeation rate of the resultant membrane.

According to the present invention, a plasticizer and a good solvent for vinylidene fluoride resin are added to the above-mentioned vinylidene fluoride resin to form a starting composition for formation of the membrane.

(Plasticizer)

As the plasticizer, aliphatic polyesters of a dibasic acid and a glycol may generally be used. Examples thereof may include: adipic acid-based polyesters of, e.g., the adipic acid-propylene glycol type, and the adipic acid-1,3-butylene glycol type; sebacic acid-based polyesters of, e.g., the sebacic acid-propylene glycol type; and azelaic acid-based polyesters of, e.g., the azelaic acid-propylene glycol type, and azelaic acid-1,3-butylene glycol type.

(Good Solvent)

As the good solvent for vinylidene fluoride resin, those capable of dissolving vinylidene fluoride resin in a temperature range of 20-250° C. may be used. Examples thereof may include: N-methylpyrrolidone, dimethylformamide, dimethylacetamide, dimethyl sulfoxide, methyl ethyl ketone, acetone, tetrahydrofuran, dioxane, ethyl acetate, propylene carbonate, cyclohexane, methyl isobutyl ketone, dimethyl phthalate, and solvent mixtures of these. N-methylpyrrolidone (NMP) is particularly preferred in view of its stability at high temperatures.

(Composition)

The starting composition for formation of the membrane may preferably be obtained by mixing 100 wt. parts of the vinylidene fluoride resin with 70-250 wt. parts of the plasticizer and 5-80 wt. parts of the good solvent for vinylidene fluoride resin.

If the plasticizer is below 70 wt. parts, the porosity is lowered to result in an inferior filtration performance (water permeation rate) of the hollow-fiber porous membrane, and the effect of promoting the network texture through fine crystallization of the vinylidene fluoride resin is liable to be impaired. On the other hand, in excess of 250 wt. parts, the porosity becomes excessively large to result in a lower mechanical strength.

If the good solvent is below 5 wt. parts, it becomes impossible to uniformly mix the vinylidene fluoride resin and the plasticizer, or a long time is required for the mixing. On the other hand, in excess of 80 wt. parts, it becomes impossible to attain a porosity corresponding to the added amount of the plasticizer. In other words, the effective pore formation by extraction of the plasticizer is obstructed.

The total amount of the plasticizer and the good solvent is preferably in the range of 100-250 wt. parts. Both of them have a function of lowering the viscosity of the melt-extrusion composition and they function interchangeably with each other to some extent. Among them, the proportion of the solvent is preferably 5-40 wt. %, more preferably 10-35 wt. %. If the plasticizer is less than 60 wt. % of the total of the plasticizer and the good solvent, the crystallization in the cooling bath is liable to be insufficient, thus being liable to cause collapsion of the hollow-fiber.

(Mixing and Melt-Extrusion)

The melt-extrusion composition may be extruded into a hollow fiber film by extrusion through an annular nozzle at a temperature of 140-270° C., preferably 150-200° C. Accordingly, the manners of mixing and melting of the vinylidene fluoride resin, plasticizer and good solvent are arbitrary as far as a uniform mixture in the above-mentioned temperature range can be obtained consequently.

According to a preferred embodiment for obtaining such a composition, a twin-screw kneading extruder is used, and the vinylidene fluoride resin (preferably in a mixture of a principal resin and a crystallinity-modifier resin) is supplied from an upstream side of the extruder and a mixture of the plasticizer and the good solvent is supplied at a downstream position to be formed into a uniform mixture until they pass through the extruder and are discharged. The twin-screw extruder may be provided with a plurality of blocks capable of independent temperature control along its longitudinal axis so as to allow appropriate temperature control at respective positions depending on the contents of the materials passing therethrough.

(Cooling)

According to the process of the present invention, the melt-extruded hollow fiber film is cooled preferentially from an outside thereof and solidified by introducing it into a bath of cooling medium containing at least 30 wt. % of a good solvent for vinylidene fluoride resin. As the good solvent, one which is similar (not necessarily, identical) to the good solvent used for forming the above-mentioned film-forming composition, may be used, and NMP (N-methylpyrrolidone) is most preferred. Another component to be mixed with the good solvent for forming the cooling medium may be a liquid, which is inert (i.e., non-solvent for and non-reactive) with vinylidene fluoride resin, but water showing good mutual solubility with NMP and having a large heat capacity, is most preferred. The proportion of the good solvent in the cooling medium needs to be at least 30 wt. % and may preferably be in the range of 30-90 wt. %, particularly 40-80 wt. %. Below 30 wt. %, the resultant hollow-fiber porous membrane fails to have a sufficiently large outer-surface average pore size P1, so that the formation of a minimum pore size layer inside the membrane, as the object of the present invention, becomes insufficient. On the other hand, if the proportion of the good solvent is excessively large, the melt-extruded hollow-fiber film is liable to be collapsed due to insufficient solidification of the surface layer portion during the cooling for solidification thereof. The temperature of the cooling medium may be selected from a fairly wide temperature range of 0-120° C., but may preferably be in a range of 5-100° C., particularly 5-80° C.

(Extraction)

The cooled and solidified hollow fiber film is then introduced into an extraction liquid bath to remove the plasticizer and the good solvent therefrom, thereby forming a hollow fiber membrane. The extraction liquid is not particularly restricted provided that it does not dissolve the vinylidene fluoride resin while dissolving the plasticizer and the good solvent. Suitable examples thereof may include: polar solvents having a boiling point on the order of 30-100° C., inclusive of alcohols, such as methanol and isopropyl alcohol, and chlorinated hydrocarbons, such as dichloromethane and 1,1,1-trichloroethane.

(Stretching)

The hollow-fiber film or membrane after the extraction may preferably be subjected to stretching in order to increase the porosity and pore size and improve the strength-elongation characteristic thereof. The stretching may preferably be effected as a uniaxial stretching in the longitudinal direction of the hollow-fiber membrane by means of, e.g., a pair of rollers rotating at different circumferential speeds. This is because it has been formed that a microscopic texture including a stretched fibril portion and a non-stretched node portion appearing alternately in the stretched direction is preferred for the hollow-fiber porous membrane of vinylidene fluoride resin of the present invention to exhibit a harmony of porosity and strength-elongation characteristic thereof. The stretching ratio may suitably be on the order of 1.2-4.0 times, particularly 1.4-3.0 times. It is preferred to heat-treat the hollow-fiber film or membrane for 1 sec.-18000 sec., preferably 3 sec.-3600 sec., in a temperature range of 80-160° C., preferably 100-140° C. to increase the crystallinity in advance of the stretching for the purpose of improving the stretchability.

(Wetting Treatment)

According to the present invention, a porous hollow-fiber membrane of the present invention is obtained in the above-described manner, but it is preferred to subject the membrane to a wetting treatment with a liquid wetting the hollow-fiber membrane of vinylidene fluoride resin. This is because, by the wetting treatment, the water permeability of the hollow-fiber porous membrane of the present invention can be increased remarkably without substantially impairing the characteristics thereof.

A liquid having a surface tension (JIS K6768) smaller than a wet tension of vinylidene fluoride resin may be used as a wetting liquid for the porous membrane of vinylidene fluoride resin. More specifically, the wetting liquid may be selected from alcohols, such as methanol, ethanol and isopropanol, and halogenated hydrocarbons, such as dichloromethane and 1,1,1-trichloroethane and may preferably be a polar solvent having a boiling point of, ca. 30-100° C.

In the wetting treatment, a hollow-fiber porous membrane having been subjected to stretching may preferably be also subjected to a relaxation treatment. The relaxation of a hollow-fiber porous membrane in a wet state may preferably be effected by passing such a porous membrane wetted with a wetting liquid through a pair of an upstream roller and a downstream roller rotating at successively decreasing circumferential speeds.

Even at a small value of the relaxation percentage determined by (1−(the downstream roller circumferential speed/the upstream roller circumferential speed))×100(%), a certain effect of increasing the water permeability can be attained, but in order to attain a further effective result, the relaxation percentage may preferably be in a range of 2-50%, particularly 5-30%. Below 2%, the effect by the relaxation may not be remarkable, and a relaxation percentage in excess of 50% is difficult to achieve while it depends on a stretching ratio applied to the porous membrane to be relaxed so that it becomes difficult to obtain a hollow-fiber porous membrane through the desired degree of relaxation.

The wet state as an environment for effecting the relaxation of a hollow-fiber porous membrane subjected to stretching as described above may conveniently be formed as a state of the porous membrane immersed in a wetting liquid, but it is also possible to dip a porous membrane within a wetting liquid to impregnate the porous membrane with the wetting liquid and then introduce the porous membrane into a liquid not wetting vinylidene fluoride resin (e.g., water) or a gas such as air, to cause the relaxation.

The relaxation temperature may preferably be 0-100° C., particularly 5-80° C. The time for the relaxation treatment may be a short period or a long period as far as a desired relaxation percentage can be attained. It is generally within a range of ca. 5 sec to 1 min., but it is not necessary to be in this range.

A remarkable effect of the above-mentioned relaxation treatment in a wet state is an increase in water permeability of the resultant hollow-fiber porous membrane, whereas the pore size distribution is not substantially changed and the porosity tends to be somewhat lowered. The thickness of the porous membrane is not substantially changed, whereas the inner diameter and the outer diameter of the hollow-fiber membrane tend to be increased.

It is also preferred to effect a dry heat-relaxation treatment in a gas, such as air, before and/or after, particularly after the above-mentioned wet relaxation treatment. By such a dry heat-relaxation treatment, it is difficult to expect an effect of increasing the water permeability (i.e., substantially no change in water permeability is caused) but the pore sizes are somewhat decreased and uniformized, so that an improved performance in separation of fine particles within a liquid to be processed through the porous membrane can be attained. It should be noted, however, that a relaxation treatment in air immediately after the wet relaxation treatment also results in an effect of wet relaxation owing to the wetting liquid remaining in the porous membrane.

The dry heat-relaxation treatment may be preferably performed at a temperature of 80-160° C., particularly 100-140° C., so as to effect a relaxation percentage of ca. 0-10%, particularly 2-10%. The relaxation percentage of 0% corresponds to, e.g., a heat-fixation treatment after the wet relaxation.

(Hollow-Fiber Porous Membrane of Vinylidene Fluoride Resin)

The hollow-fiber porous membrane of the present invention obtained through a series of the above-mentioned steps is characterized as a hollow-fiber-form porous membrane in a network texture of vinylidene fluoride resin showing a pore size distribution in a direction of its membrane thickness including an outer surface-average pore size P1 as measured by a scanning electron microscope and a membrane layer-average pore size P2 as measured by half-dry method giving a ratio P1/P2 of at least 2.5, whereby a minimum pore size layer is presumably formed inside or at an inner surface of the membrane.

More specifically, the ratio P1/P2 of at least 2.5 between the outer surface-average pore size P1 determined through image analysis (of which the details will be described later) of a SEM photograph obtained by observation through a SEM of an outer surface of a porous membrane and the average pore size P2 measured by the half-dry method is effective for achieving the object of the present invention, i.e., an increased effect of recovery of water permeability by air scrubbing. The upper limit of P1/P2 is not particularly restricted but may ordinarily be at most 5, particularly at most 4.

Further more specifically, as for the pore size distribution in the thickness direction of a hollow-fiber porous membrane for use in water treatment, it is preferred that the outer surface-average pore size P1 is 0.20-0.60 μm, the membrane layer-average pore size P2 is 0.05-0.20 μm, and the porous membrane also has an inner surface-average pore size P3 as measured by the SEM observation of 0.25-0.60 μm. Owing to the relatively small inner surface-average pore size of 0.25-0.60 μm, an inner surface region contributing relatively little to the filtration performance contributes to an increase in overall strength of the hollow-fiber porous membrane, thereby giving a durability suitable for washing by air scrubbing.

Other general features of hollow-fiber porous membranes obtained according to the present invention may include: a porosity of 55-90%, preferably 60-85%, particularly preferably 65-80%; a tensile strength of at least 6 MPa, preferably at least 8 MPa, particularly preferably at least 10 MPa; an elongation at break of at least 5%, preferably at least 10%, particularly preferably at least 20%; and when used as a water-filtering membrane, a water permeation rate of at least 5 m³/m²·day at 100 kPa. The thickness is ordinarily in the range of 5-800 μm, preferably 50-600 μm, particularly preferably 150-500 μm. The outer diameter of the hollow fiber may suitably be on the order of 0.3-3 mm, particularly ca. 1-3 mm.

Further, a micro-texture characteristic of the hollow-fiber porous membrane according to the present invention obtained through the stretching is that it comprises a crystalline oriented portion and a crystalline non-oriented portion (random oriented portion) recognizable by X-ray diffraction, which are understood as corresponding to a stretched fibril portion and a non-stretched node portion, respectively.

The hollow-fiber porous membrane of the present invention may be housed within a hollow-fiber membrane module of a so-called outside pressure-type or a so-called immersion-type wherein a supply water contacts the outer surface of the hollow-fiber membrane and may be used in a water filtration method including a step of feeding and passing a supply water from an outer surface-side of the hollow-fiber porous membrane to perform filtration, and a step of washing the hollow-fiber porous membrane by air scrubbing.

A suitable example of the outside pressure-type module may be one including a tubular housing with a circular or rectangular section, and a bundle of a multitude of hollow-fiber porous membranes is accommodated within the tubular housing so that both ends of the hollow-fiber bundle are secured by adhesion to both ends of the housing, one of the adhesion-securing ends is formed as a resinous partitioning wall separating a filtration chamber (a module inner section) and a filtered water chamber (a water collection section), the other adhesion-securing end is formed as a resinous wall for defining the filtration chamber in a liquid-tight manner, one-side ends of the hollow-fiber bundle are exposed open to the filtered water chamber at the resinous partitioning wall end, and the other-side ends of the hollow-fiber bundle are embedded and closed within the resinous wall, so as to form a module including the hollow-fiber bundle which is supported at both ends and is open at one end. Particularly, it is preferred to use a module wherein a gas intake port for air scrubbing is provided at the resinous wall on the other side, or a supply water-feed port formed in the resinous water can be switched as desired for feeding the supply water or for feeding an air scrubbing gas.

Suitable examples of the immersion-type module may include: an immersion type module wherein a multitude of hollow-fiber porous membranes are formed into a character “U”-shaped bundle so as to keep both ends open and both ends of the hollow-fiber bundle are secured at one place each by adhesion to a securing member having a circular or elongated rectangular section perpendicular to the hollow-fibers so as to leave the U-character top section freely movable, and an immersion-type module wherein a multitude of hollow-fiber porous membranes are arranged in the form of a reed screen so as to keep open ends of the hollow-fiber membrane at both sides or one side, and both sides of the hollow-fiber membranes are separately secured by adhesion to securing members having an elongated rectangular section perpendicular to the hollow-fiber membranes. These immersion-type modules are stacked in a plurality thereof and secured in position via the securing members to a supply water vessel (an activated sludge vessel or a settler vessel) and subjected to washing according to air scrubbing by introducing an air scrubbing gas through gas-dispersion pipes disposed at the bottom of the supply water vessel.

The air scrubbing conditions may vary depending on the degree of soiling of the membranes during the water-filtering operation. The air scrubbing operation may be performed as required when a water flow rate is lowered down to a certain level in the case of a constant pressure-filtration, or when a pressure difference through the membranes is increased to a certain level in the case of a constant flow rate-filtration, so as to achieve an effective result. More specifically, the air scrubbing operation may preferably be performed once per a filtration period of 3 minutes to 5 hours. One air scrubbing operation may preferably be continued for a period of 1 minute to 10 minutes. In case where the recovery of water permeability is insufficient even after repetition of several times of air scrubbing, a reverse washing or a chemical washing can be performed in combination therewith.

### EXAMPLES

Hereinbelow, the present invention will be described more specifically based on Examples and Comparative Examples. The properties described herein including those described below are based on measured values according to the following methods.

(Weight-Average Molecular Weight (Mw))

A GPC apparatus (“GPC-900”, made by Nippon Bunko K.K.) was used together with a column of “Shodex KD-806M” and a pre-column of “Shodex KD-G” (respectively made by Showa Denko K.K.), and measurement according to GPC (gel permeation chromatography) was performed by using NMP as the solvent at a flow rate of 10 ml/min. at a temperature of 40° C. to measure polystyrene-based molecular weights.

(Crystalline Melting Points Tm1, Tm2, Crystal Melting Enthalpy and Crystallization Temperature Tc)

A differential scanning calorimeter “DSC-7” (made by Perkin-Elmer Corp.) was used. A sample resin of 10 mg was set in a measurement cell, and in a nitrogen gas atmosphere, once heated from 30° C. up to 250° C. at a temperature-raising rate of 10° C./min., then held at 250° C. for 1 min. and cooled from 250° C. down to 30° C. at a temperature-lowering rate of 10° C./min., thereby to obtain a DSC curve. On the DSC curve, an endothermic peak temperature in the course of heating was determined as a melting point Tm1 (° C.), and a heat of absorption by the endothermic peak giving Tm1 was measured as a crystal melting enthalpy. Further, an exothermic peak temperature in the course of cooling was determined as a crystallization temperature Tc (° C.). Successively thereafter, the sample resin was held at 30° C. for 1 min., and re-heated from 30° C. up to 250° C. at a temperature-raising rate of 10° C./min. to obtain a DSC curve. An endothermic peak temperature on the re-heating DSC curve was determined as an inherent melting point Tm2 (° C.) defining the crystallinity of vinylidene fluoride resin in the present invention.

(Porosity)

The length and also the outer diameter and inner diameter of a sample hollow fiber porous membrane were measured to calculate an apparent volume V (cm³) of the porous membrane, and the weight W (g) of the porous membrane was measured to calculate a porosity according to the following formula:

Porosity (%)=(1−W/(V×ρ))×100,

wherein ρ: density of PVDF(=1.78 g/cm³)

(Water Permeation Rate (Flux))

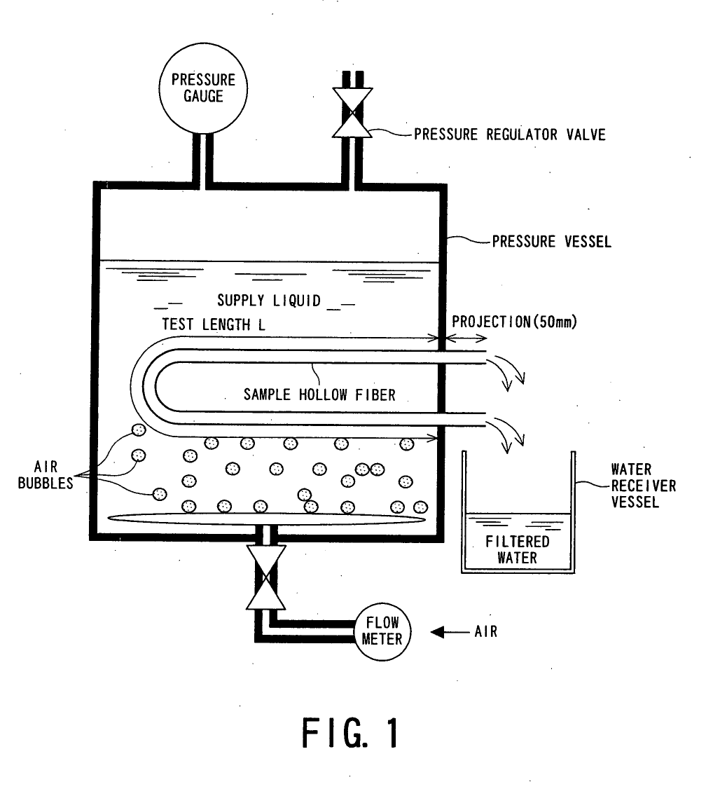

A sample hollow fiber porous membrane was immersed in ethanol for 15 min., then immersed in water to be hydrophilized, and then subjected to a measurement at a water temperature of 25° C. and a pressure difference of 100 kPa. The test length (i.e., length of a portion used for filtration) L (as shown in FIG. 1) of hollow fiber porous membrane was set to 800 mm, and the area of the membrane was calculated based on the outer diameter according to the following formula:

Membrane area (m²)=(outer diameter)×π×(test length).

(Average Pore Size)

An average pore size (diameter) was measured according to the half dry method based on ASTM F316-86 and ASTM E1294-89 by using “PERMPOROMETER CFP-2000AEX” made by Porous Materials, Inc. A perfluoropolyester (trade name “Galwick”) was used as the test liquid.

(Tensile Strength and Elongation at Break)

Measured by using a tensile tester (“RTM-100”, made by Toyo Baldwin K.K.) under the conditions of an initial sample length of 100 mm and a crosshead speed of 200 mm/min. in an environment of a temperature of 23° C. and a relative humidity of 50%.

(Blocking Rate of Polystyrene Latex Particles)

A rate of blocking of polystyrene latex particles was measured in order to evaluate a minute particle removing performance of a hollow-fiber porous membrane as a separating membrane for water treatment. More specifically, a 10 wt. % latex of polystyrene particles with a monodisperse particle size of 0.262 μm (made by Ceradine K.K.) was diluted to form a sample supply liquid of 200 mm. Then, a porous hollow-fiber sample at a length L=800 mm, which had been subjected to hydrophilization with ethanol followed by replacement with water, was set in a flux meter (as shown in FIG. 1) and used for filtrating 1 liter of the sample supply liquid at a constant pressure of 10 kPa to obtain a filtered liquid. The supply liquid and the filtered liquid were subjected to measurement of absorbance spectra by means of an ultraviolet-visible spectrophotometer (“UV-2200”, made by K.K. Shimadzu Seisakusho) to obtain peak absorbances, from which the concentrations of the respective liquids were determined. A blocking rate was determined from Formula (1) below. Incidentally, a calibration curve of absorbances versus concentrations of polystyrene latex particles was prepared in advance of the measurement to confirm a linearity between peak absorbances and concentrations in a concentration range of 0.3-10 ppm.

R=(1−Cp/Cb)×100 (1),

wherein R (%): blocking rate, Cb: concentration in the supply liquid, and Cp: concentration in the filtered liquid.

(Retention of Flux (Water Permeability))

A filtration test was performed by using a river surface water sampled from Koisegawa-river in Ishioka-city, Ibaraki-prefecture, Japan, as a supply water to evaluate the resistance to clogging and recovery by washing. The supply water exhibited a turbidity of 4.6 NTU (nephelometric turbidity unit; corresponding to a turbidity of water containing kaolin at a concentration of ca. 28 (=4.6×0.6) mg/L), and a chromaticity of 21.3 degree (corresponding to a chromaticity of 1 L (liter) of water to which 21.3 mL of a chromaticity standard liquid (containing 1 mg of platinum and 0.5 mg of cobalt in 1 mL thereof has been added).

First of all, a sample hollow-fiber porous membrane was immersed in ethanol for 15 min. and then in pure water for 15 min. to be wetted, and attached to an apparatus as shown in FIG. 1 so as to provide a test length L of 800 mm while leaving both ends thereof as projections out of the pressure vessel. The projections (which were portions not used for filtration and included connections with the pressure vessel) were 50 mm each at both ends. The pressure vessel was filled with pure water (at 25° C.) so as to fully immerse the porous hollow-fiber until the completion of the measurement, and filtration was performed while maintaining the pressure in the pressure vessel at 50 kPa. A weight (g) of filtered water having flowed out of both ends in a first 1 min. after initiation of the filtration was recorded as an initial water permeability.

Then, the pressure vessel was filled with the supply water (at 25° C.) in place of the pure water so as to fully immerse the porous hollow-fiber until the completion of the measurement, and then filtration was performed for 30 min. while maintaining the pressure in the pressure vessel at 50 kPa. A weight of the water having flowed out of (the projections at) both ends in 1 min. from 29 min. to 30 min. after the initiation of the filtration was recorded as a water permeability after 30 min. of filtration to calculate a retention of flux (water permeability) according to the following formula:

Flux retention (%)=(water permeability after 30 min. of filtration (g)/(initial water permeability (g))×100

Then, as illustrated in FIG. 1, air was introduced from a lower part of the pressure vessel for 1 min. at a rate of 70 ml/min. to effect washing by air scrubbing. Thereafter, filtration of the supply water was performed for 1 min. while maintaining the pressure in the pressure gauge at 50 kPa to measure a weight of water having flowed out of both ends as a water permeability after 1 min. of air scrubbing, from which flux retention after air scrubbing was determined according to the following formula:

Flux retention after air scrubbing (%)=(water permeability in 1 min. after air scrubbing (g)/(initial water permeability (g))×100

### Example 1

A principal polyvinylidene fluoride (PVDF) (powder) having a weight-average molecular weight (Mw) of 4.12×10⁵ and a crystallinity-modifier polyvinylidene fluoride (PVDF) (powder) having Mw=9.36×10⁵ were blended in proportions of 95 wt. % and 5 wt. %, respectively, by a Henschel mixer to obtain a mixture A having Mw=4.38×10⁵.

An adipic acid-based polyester plasticizer (“PN-150”, made by Asahi Denka Kogyo K.K.) as an aliphatic polyester and N-methyl-pyrrolidone (NMP) as a solvent were mixed under stirring in a ratio of 82.5 wt. %/17.5 wt. % at room temperature to obtain a mixture B.

An equi-directional rotation and engagement-type twin-screw extruder (“BT-30”, made by Plastic Kogaku Kenkyusyo K.K.; screw diameter: 30 mm, L/D=48) was used, and the mixture A was supplied from a powder supply port at a position of 80 mm from the upstream end of the cylinder and the mixture B heated to 160° C. was supplied from a liquid supply port at a position of 480 mm from the upstream end of the cylinder at a ratio of mixture A/mixture B=35.7/64.3 (wt. %), followed by kneading at a barrel temperature of 220° C. to extrude the melt-kneaded product through a nozzle having an annular slit of 6 mm in outer diameter and 4 mm in inner diameter into a hollow fiber-form extrudate at a rate of 11.8 g/min. In this instance, air was injected into a hollow part of the fiber at a rate of 3.8 ml/min. through an air supply port provided at a center of the nozzle.

The extruded mixture in a molten state was introduced into a cooling bath of a water/NMP (25/75 wt. %) mixture maintained at 25° C. and having a surface 280 mm distant from the nozzle (i.e., an air gap of 280 mm) to be cooled and solidified (at a residence time in the cooling bath of ca. 3 sec.), pulled up at a take-up speed of 10 m/min. and wound up about a reel of ca. 1 m in diameter to obtain a first intermediate form.

Then, the first intermediate form was immersed under vibration in dichloromethane at room temperature for 30 min, followed by immersion in fresh dichloromethane again under the same conditions to extract the plasticizer and solvent and further by 1 hour of heating in an oven at 120° C. for removal of the dichloromethane and heat treatment, thereby to obtain a second intermediate form.

Then, the second intermediate form was longitudinally stretched at a ratio of 2.2 times by passing it by a first roller at a speed of 12.5 m/min., though a water bath at 60° C. and by a second roller at a speed of 27.5 m/min. Then, the intermediate form was caused to pass through a bath of dichloromethane controlled at 5° C. and by a third roller at a lowered speed of 26.1 m/min. to effect a 5%-relaxation treatment in the dichloromethane bath. The form was further caused to pass through a dry heating bath (of 2.0 m in length) controlled at a spatial temperature of 140° C. and by a fourth roller at a lowered speed of 24.8 m/min. to effect a 5%-relaxation treatment in the dry heating bath and was taken up to provide a polyvinylidene fluoride-based hollow-fiber porous membrane (a third form).

The resultant polyvinylidene fluoride-based hollow-fiber porous membrane exhibited an outer diameter of 1.002 mm, an inner diameter of 0.567 mm, a membrane thickness of 0.218 mm, a porosity of 73%, a pure water permeability of 52.1 m³/m²·day (100 kPa, L=800 mm), a flux retention of 45.0%, a flux retention after air scrubbing of 89%, a blocking rate of polystyrene latex particles (0.262 μm) of 100%, an average pore size P2 according to the half dry method of 0.151 μm, a tensile strength of 13.9 MPa, an elongation at break of 17%, and a tensile modulus of 144 MPa. Further, according to the SEM observation, the porous membrane exhibited an outer surface average pore size P1=0.461 μm, an inner surface average pore size P3=0.438 μm and a ratio P1/P2 of 3.05.

The production conditions and physical properties of the thus-obtained polyvinylidene fluoride-based hollow-fiber porous membrane are inclusively shown in Table 1 appearing hereinafter together with the results of the following Examples and Comparative Examples.

### Example 2

The principal PVDF and the modifier PVDF were blended in proportions of 90 wt. % and 10 wt. %, respectively, to obtain a mixture A.

A hollow-fiber porous membrane was obtained in the same manner as in Example 1 except for using the mixture A and extruding a molten mixture of the mixture A and the mixture B at an increased nozzle ejection rate of 13.6 g/min. into a hollow fiber-form while supplying air at an increased rate of 4.8 ml/min. to the nozzle center, followed by cooling and solidification by introduction into a cooling bath at 10° C. to form a first intermediate form and stretching of a second intermediate form at a ratio of 1.8 times.

### Example 3

A hollow-fiber porous membrane was obtained in the same manner as in Example 2 except for using a mixture A having Mw=4.91×10⁵ obtained by blending the principal PVDF and the modifier PVDF in proportions of 85 wt. % and 15 wt. %, respectively.

### Example 4

A hollow-fiber porous membrane was obtained in the same manner as in Example 1 except for changing the cooling bath temperature to 10° C. and the stretching ratio to 1.8 times.

### Example 5

A hollow-fiber porous membrane was obtained in the same manner as in Example 1 except for changing the proportions of water and NMP forming a mixture liquid constituting the cooling bath for solidification and forming into a hollow fiber film of the melt extruded mixture to water/NMP=50/50 wt. %.

### Comparative Example 1

A hollow-fiber porous membrane was obtained in the same manner as in Example 1 except for changing the proportions of water/NMP forming a mixture liquid constituting the cooling bath to 75/25 wt. %.

### Comparative Example 2

A hollow-fiber porous membrane was obtained in the same manner as in Example 1 except for changing the cooling bath composition to 100% of water (water/NMP=100/0 wt. %).

### Comparative Example 3

The production of a hollow-fiber porous membrane was tried in the same manner as in Example 1 except for changing the cooling bath composition to 100% of NMP, whereas the hollow fiber film was collapsed in the cooling bath so that the operation from the stretching and so on was impossible, thus failing to provide a hollow-fiber.

### Comparative Example 4

The production of a hollow-fiber porous membrane was tried in the same manner as in Example 1 except for using 100% of NMP instead of the mixture B, whereas the hollow fiber film was collapsed in the cooling bath so that the operation from the stretching and so on was impossible, thus failing to provide a hollow-fiber.

The outline of the above-described Examples and Comparative Examples, and the physical properties of the resultant hollow-fiber porous membranes are inclusively shown in the following Table 1.

TABLE 1

| Example | | | 1 | 2 | 3 | 4 | 5 |
|---|---|---|---|---|---|---|---|
| Starting | Mixture A | Principal PVDF's Mw (×10⁵) | 4.12 | 4.12 | 4.12 | 4.12 | 4.12 |
| material | | Modifier PVDF's Mw (×10⁵) | 9.36 | 9.36 | 9.36 | 9.36 | 9.36 |
| composition | | PVDF mixing ratio (wt. %) | 95/5 | 90/10 | 85/15 | 95/5 | 95/5 |
| | | Mixture's Mw (×10⁵) | 4.38 | 4.64 | 4.91 | 4.38 | 4.38 |
| | Mixture B | Polyester Plasticizer | PN-150 | PN-150 | PN-150 | PN-150 | PN-150 |
| | | Solvent | NMP | NMP | NMP | NMP | NMP |
| | | Plasticizer/solvent mixing | 82.5/17.5 | 82.5/17.5 | 82.5/17.5 | 82.5/17.5 | 82.5/17.5 |
| | | ratio (wt. %) | | | | | |
| | Mixture A/Mixture B Supply ratio (wt. %) | | 35.7/64.3 | 35.7/64.3 | 35.7/64.3 | 35.7/64.3 | 35.7/64.3 |
| cooling | Water/NMP tatio (wt. %) | | 25/75 | 25/75 | 25/75 | 25/75 | 50/50 |
| conditions | cooling bath temp. (° C.) | | 25 | 10 | 10 | 10 | 25 |
| Streching & | Strech temp.(° C.) | | 60 | 60 | 60 | 60 | 60 |
| relaxation | Strech ratio | | 2.2 | 1.8 | 1.8 | 1.8 | 2.2 |
| conditions | Relaxation liquid medium | | CH₂Cl₂ | CH₂Cl₂ | CH₂Cl₂ | CH₂Cl₂ | CH₂Cl₂ |
| | Relaxation ratio in liquid (%) | | 5 | 5 | 5 | 5 | 5 |
| | Relaxation temp. in air (° C.) | | 140 | 140 | 140 | 140 | 140 |
| | Relaxation ratio in air (%) | | 5 | 5 | 5 | 5 | 5 |
| Physical | Outer diameter (mm) | | 1.002 | 1.118 | 1.144 | 1.1118 | 1.006 |
| properties | Inner diameter (mm) | | 0.567 | 0.650 | 0.698 | 0.662 | 0.588 |
| | Thickness (mm) | | 0.218 | 0.234 | 0.223 | 0.228 | 0.209 |
| | Porosity (%) | | 73 | 70 | 67 | 69 | 73 |
| | Water permeability (m3/(m2 · day)(100 kPa, L = 800 mm) | | 52.1 | 48.6 | 39.4 | 35.6 | 50.2 |
| | Flux retention (%) | | 45.0 | 43.7 | 40.5 | 39.7 | 31.8 |
| | Fulax retention after air scruffing (%) | | 89.4 | 88.2 | 86.3 | 85.9 | 60.5 |
| | Ave. pore size P1 (μm)(half dry) | | 0.151 | 0.133 | 0.114 | 0.116 | 0.122 |
| | SEM outer surface pore size P2 (μm) | | 0.461 | 0.431 | 0.418 | 0.427 | 0.330 |
| | SEM inner surface pore size P3 (μm) | | 0.438 | 0.419 | 0.397 | 0.405 | 0.428 |
| | P2/P1 | | 3.05 | 3.24 | 3.66 | 3.67 | 2.70 |
| | Tensile strength (MPa) | | 13.9 | 12.2 | 13.5 | 11.8 | 15.7 |
| | Elongation at break (%) | | 17 | 27 | 33 | 45 | 37 |
| | Tensile modulus (MPa) | | 144 | 154 | 186 | 145 | 164 |

| | | | | | |
|---|---|---|---|---|---|
| Latex particle (0.262 μm)blocking rate (%) | 100 | 100 | 100 | 100 | 100 |

| Example | | | Comp. 1 | Comp. 2 | Comp. 3 *1 | Comp. 4 *1 |
|---|---|---|---|---|---|---|
| Starting | Mixture A | Principal PVDF's Mw (×10⁵) | 4.12 | 4.12 | 4.12 | 4.12 |
| material | | Modifier PVDF's Mw (×10⁵) | 9.36 | 9.36 | 9.36 | 9.36 |
| composition | | PVDF mixing ratio (wt. %) | 95/5 | 95/5 | 95/5 | 95/5 |
| | | Mixture's Mw (×10⁵) | 4.38 | 4.38 | 4.38 | 4.38 |
| | Mixture B | Polyester Plasticizer | PN-150 | PN-150 | PN-150 | — |
| | | Solvent | NMP | NMP | NMP | NMP |
| | | Plasticizer/solvent mixing | 82.5/17.5 | 82.5/17.5 | 82.5/17.5 | 0/100 |
| | | ratio (wt. %) | | | | |
| | Mixture A/Mixture B Supply ratio (wt. %) | | 35.7/64.3 | 35.7/64.3 | 35.7/64.3 | 35.7/64.3 |
| cooling | Water/NMP tatio (wt. %) | | 75/25 | 100/0 | 0/100 | 25/75 |
| conditions | cooling bath temp. (° C.) | | 25 | 25 | 25 | 25 |
| Streching & | Strech temp.(° C.) | | 60 | 60 | | |
| relaxation | Strech ratio | | 2.2 | 2.2 | | |
| conditions | Relaxation liquid medium | | CH₂Cl₂ | CH₂Cl₂ | | |
| | Relaxation ratio in liquid (%) | | 5 | 5 | | |
| | Relaxation temp. in air (° C.) | | 140 | 140 | | |
| | Relaxation ratio in air (%) | | 5 | 5 | | |
| Physical | Outer diameter (mm) | | 1.025 | 1.035 | | |
| properties | Inner diameter (mm) | | 0.594 | 0.604 | | |
| | Thickness (mm) | | 0.216 | 0.215 | | |
| | Porosity (%) | | 71 | 73 | | |
| | Water permeability (m3/(m2 · day)(100 kPa, L = 800 mm) | | 40.4 | 39.3 | | |
| | Flux retention (%) | | 23.1 | 20.2 | | |
| | Fulax retention after air scruffing (%) | | 45.2 | 41.3 | | |
| | Ave. pore size P1 (μm)(half dry) | | 0.109 | 0.104 | | |
| | SEM outer surface pore size P2 (μm) | | 0.237 | 0.219 | | |
| | SEM inner surface pore size P3 (μm) | | 0.386 | 0.407 | | |
| | P2/P1 | | 2.17 | 2.11 | | |
| | Tensile strength (MPa) | | 15.3 | 14.8 | | |
| | Elongation at break (%) | | 44 | 42 | | |
| | Tensile modulus (MPa) | | 164 | 172 | | |

| | | |
|---|---|---|
| Latex particle (0.262 μm)blocking rate (%) | 100 | 100 |

*1: Hollow fiber production in Comparative Example 3 and Comparative Example 4 was impossibile.

### INDUSTRIAL APPLICABILITY

As is clear from the results shown in Table 1 above, according to the present invention, a mixture of vinylidene fluoride resin, a plasticizer and a good solvent for vinylidene fluoride resin, is melt-extruded into a hollow-fiber-form, and cooled for solidification and film formation in a cooling medium which contains a certain proportion or more of a good solvent for vinylidene fluoride resin, thereby providing a hollow-fiber porous membrane suitable for water treatment and reproducible by simple air scrubbing operation.

1. A hollow-fiber porous membrane, comprising a hollow fiber-form porous membrane in a network texture of vinylidene fluoride resin showing a pore size distribution in a direction of its membrane thickness including an outer surface-average pore size P1 of 0.20-0.60 μm and an inner surface-average pore size P3 of 0.25-0.60 μm as measured by a scanning electron microscope and a membrane layer-average pore size P2 of 0.05-0.20 μm as measured by half-dry method giving a ratio P1/P2 of at least 2.5.

2. (canceled)

3. A hollow-fiber porous membrane according to claim 1, having a porosity of 55-80% and a tensile break strength of at least 6 MPa.

4. A hollow-fiber porous membrane according to claim 1, for use in a water filtration method including a step of feeding and passing a supply water from an outer surface-side to an inner surface-side of the hollow-fiber porous membrane to perform filtration, and a step of washing the hollow-fiber porous membrane by air scrubbing.

5. A water filtration method, comprising: a step of feeding and passing a supply water from an outer surface-side to an inner surface-side of a hollow-fiber porous membrane according to claim 1 to perform filtration, and a step of washing the hollow-fiber porous membrane by air scrubbing.

6. A process for producing a hollow-fiber porous membrane of vinylidene fluoride resin according to claim 1, comprising:
adding, to 100 wt. parts of vinylidene fluoride resin, 70-250 wt. parts of a plasticizer and 5-80 wt. parts of a good solvent for vinylidene fluoride resin to form a composition,
melt-extruding the composition into a hollow fiber film,
introducing the hollow-fiber film into a cooling medium to cool and solidify the film preferentially from its outer surface, and
extracting the plasticizer from the hollow-fiber film to provide a hollow-fiber porous membrane,
wherein the cooling medium for solidifying the film is caused to contain at least 30 wt. % of a good solvent for vinylidene fluoride resin.

7. A production process according to claim 6, including a step of stretching the hollow-fiber porous membrane after extracting the plasticizer.

8. A production process according to claim 7, including a step of wet-treating the hollow-fiber porous membrane after the stretching step with a liquid wetting the vinylidene fluoride resin porous membrane.

9. A production process according to claim 6, wherein in the step of melt-extruding the composition into a hollow-fiber film, an inert gas is injected into a hollow part of the hollow-fiber film to introduce the hollow-fiber film into the cooling medium, thereby cooling and solidifying the film.

10. A hollow-fiber porous membrane according to claim 3, for use in a water filtration method including a step of feeding and passing a supply water from an outer surface-side to an inner surface-side of the hollow-fiber porous membrane to perform filtration, and a step of washing the hollow-fiber porous membrane by air scrubbing.

11. A water filtration method, comprising: a step of feeding and passing a supply water from an outer surface-side to an inner surface-side of a hollow-fiber porous membrane according to claim 3 to perform filtration, and a step of washing the hollow-fiber porous membrane by air scrubbing.

12. A production process according to claim 7, wherein in the step of melt-extruding the composition into a hollow-fiber film, an inert gas is injected into a hollow part of the hollow-fiber film to introduce the hollow-fiber film into the cooling medium, thereby cooling and solidifying the film.

13. A production process according to claim 8, wherein in the step of melt-extruding the composition into a hollow-fiber film, an inert gas is injected into a hollow part of the hollow-fiber film to introduce the hollow-fiber film into the cooling medium, thereby cooling and solidifying the film.
